(19) United States
(12) Patent Application Publication
(10) Pub. No.: US 2018/0132492 A1
(43) Pub. Date: May 17, 2018

(54) METHOD FOR PRODUCING A DOUGH PIECE

(71) Applicant: Radie B.V., BC Culemborg (NL)

(72) Inventor: Johannes Josephus Antonius VAN BLOKLAND, BG Laren (NL)

(21) Appl. No.: 15/817,112

(22) Filed: Nov. 17, 2017

(30) Foreign Application Priority Data
Nov. 17, 2016 (EP) 16199276.3

(51) Int. Cl. A21D 8/08; A21D 10/00; A21D 13/40; A21D 13/066

(52) U.S. Cl. CPC A21D 8/08; A21D 13/066; A21D 13/40; A21D 10/00

(57) ABSTRACT

The present invention relates to a method for producing a dough piece, comprising the steps of providing an elongated dough piece, curling up the dough piece into a cylindrical shape, arranging the curled up dough piece to an upright position wherein its cylinder axis is oriented substantially perpendicular to a support plane, and moulding the dough piece by compressing the dough piece in an axial direction.

### CROSS-REFERENCE TO RELATED APPLICATIONS

The present application claims priority to European Patent Application Number 16199276.3, filed on Nov. 17, 2016, and also hereby incorporated by reference

### TECHNICAL FIELD

The invention relates to a method for producing a dough piece suitable for being baked into a rounded bread. The invention further relates to a method for producing a rounded bread by applying the before-mentioned method. The invention also relates to a dough piece and a rounded bread produced using the respective methods.

### BACKGROUND

Dough rounding is used to produce ball-shaped dough pieces suitable for being baked into rounded breads or buns. A known method for obtaining rounded dough pieces involves a rounding process wherein dough pieces are rolled on a surface or between multiple surfaces. Especially with sticky dough types, the surfaces interfacing with the dough piece become heavily polluted during this process, and the dough may stick to the curling mats. Pollution is unwanted in any circumstance, but especially in case of mass produced dough products, where pollution of the machine surfaces requires short cleaning intervals resulting in lower production yields. Commonly, sticking to the surface may be prevented by applying strewing material between the surface and the dough piece. This method however only works for conventional dough compositions. For the rounding of sticky dough types like gluten-free dough, large quantities of strewing material, such as rice flour, wheat flour or starch are needed to prevent sticking, which quantities result in an unwanted change in the composition and/or consistency of the dough pieces.

### SUMMARY

It is therefore a goal of this invention to provide for a method for obtaining dough pieces, especially made from sticky dough types, suitable for being baked into rounded breads or buns that does not lead to unacceptable pollution of machine surfaces while retaining dough consistency and/or composition.

### BRIEF DESCRIPTION OF THE DRAWINGS

In order to further elucidate the invention, exemplary, non-limitative embodiments will be described with reference to the figures. In the figures:

FIG. 1 shows a perspective view of an elongated dough piece,

FIG. 2 shows a perspective view of a cylindrical shaped dough piece obtained by curling up the elongated dough piece as shown in FIG. 1,

FIG. 3 shows a perspective view of a dough piece in an upright position obtained by flipping the curled up dough piece as shown in FIG. 2,

FIG. 4 shows a perspective view of a compressed dough piece obtained by moulding the dough piece as shown in FIG. 3,

FIG. 5 shows a sectional view of a dough piece during the moulding step, and

FIG. 6 shows a perspective view of a rounded bread resulting from the baking process.

### DETAILED DESCRIPTION

The invention thereto proposes a method for producing a dough piece, comprising the steps of: A) providing an elongated dough piece, B) curling up the dough piece into a cylindrical shape, C) arranging the curled up dough piece to an upright position wherein its cylinder axis is oriented substantially perpendicular to a support plane, and D) moulding the dough piece thereby compressing the dough piece in an axial direction. By using this method, a dough piece is obtained that obviates the need for a conventional rounding process but nonetheless takes a rounded shape during baking. The individual steps of the method can furthermore be performed without significantly polluting the dough interfacing surfaces, such that it becomes possible to extend the period between consecutive cleaning operations, reducing production down times. In addition, the method does not necessitate the need to use large quantities of strewing material to prevent sticking of the dough piece to the dough interfacing surfaces.

In a specification of the method according to the invention, step B) may comprise rolling the dough piece about an axis extending in a width direction of the dough piece, perpendicular to the direction of elongation of the dough piece. During the curling up, the elongated dough piece is thus rolled over its longitudinal side, which creates a dough piece having a compact cylindrical shape that is easy to handle and resembles most closely the final shape of the dough piece.

The method according to the invention may be further specified in that the elongated dough piece provided has a width substantially equal to the diameter of an arithmetic spiral having a curve length equal to the length of the elongated dough piece and a distance between successive turnings equal to the thickness of the elongated dough piece. During the curling up of a dough piece into a cylindrical shape, the ends of the cylinder will typically take the approximate form of an arithmetic spiral (also known as a Archimedean spiral). By maintaining the width to length/thickness ratio as specified, a cylindrical dough piece is obtained, having a height that approximately equals its diameter. In particular, herein the percentage difference between the height and the diameter is preferably lower than 10% and more particular even lower than 5%.

The method may further comprise sprinkling the dough piece with strewing material prior to moulding to prevent or at least decrease the formation of pollution on the inside of the mould. Moreover, the application of strewing material prevents potential sticking of mould to the dough thereby aiding a smooth separation of the dough piece from the mould.

During moulding of the dough piece, the axial compression force exerted on the dough piece preferably introduces residual stresses into the dough piece, wherein the residual stresses decrease in outward radial direction of the dough piece. Typically, these residual stresses present in the dough will be reduced or relieved as a whole during a subsequent baking step. During baking, the dough piece will rise at a certain location to an extend proportional to the residual stresses present at said location. The presence of residual stresses that vary in magnitude in radial direction along the dough piece causes the dough to rise to a larger extend closer to the centre of the dough piece, thereby creating a rounded shape of the baked bread.

The moulding of the dough piece may comprise expanding the dough piece in a radial direction. It has been found that allowing the dough piece to expand in a radial direction will decrease the build-up of residual stresses introduced by the moulding process in an outward radial direction of the dough piece. This allows for the creation a residual stress distribution that will lead the dough piece to take a rounded shape during the baking process. More specifically the dough piece may be expanded in the radial direction to substantially the same extend as to which it is compressed in the axial direction. During experiments, it has appeared that this specific ratio of compression in axial direction and expansion in radial direction leads to a final shape of the dough piece that is best suited for being baked into a perfectly rounded bread. During the moulding, strewing material, or in the case of gluten-free dough corn starch or the like may be applied.

In order to control the radial expansion of the dough piece, the moulding of the dough piece may comprise limiting the expansion of the dough piece in a radial direction. Preferably, the expansion of the dough piece is limited by the mould itself, for example by a side wall of the mould. The mould may hereto be formed as a cylinder with a closed top and an open bottom.

The method according to the invention may further comprise transporting the dough piece in the direction of elongation of the dough piece, for example by the use of conveyors. More specifically, the dough piece may be transported between each of the processing stages defined in the method steps such that a continuous production of dough pieces becomes possible. It is hereby also possible to transport multiple dough pieces in parallel to effectively increase the throughput and output of the production process.

The method according to the invention is especially suited to follow or be part of a sheeting process, wherein dough is rolled out into a consistent dough sheet with an even thickness and cut into even elongated dough pieces.

The elongated dough piece provided may in a common case be a gluten-free bread dough piece having a composition without wheat, rye or spelt or gluten forming proteins but for instance starch such as potato starch, bean starch, corn starch, pea starch, rice flour, teff flour, tapioca flour, chicken proteins, gel formers, water, yeast and salt instead. Gluten-free dough is especially sticky and therefore in particular benefits from application of a method according to the invention.

The invention further relates to a dough piece produced using a method as described above. The main advantage of using a dough piece produced using a method according to the invention as a half-product in the production of a rounded bread is that pollution that normally occurs during rounding of the dough can be avoided or at least reduced while the rounded shape of final product (the rounded bread) is retained.

Furthermore, the invention relates to a method for producing a rounded bread comprising applying the above-described method for producing a dough piece, followed by subjecting the dough piece to a baking process. It is during the baking process that the dough piece produced using a method according to the invention through rising of the dough takes its final, rounded shape. As the dough piece produced by the method according to the invention will by itself assume a rounded shape through baking, it is preferred that the baking process enables the unbounded rising of the dough piece.

Finally, the invention relates to a rounded bread produced using the above-described method.

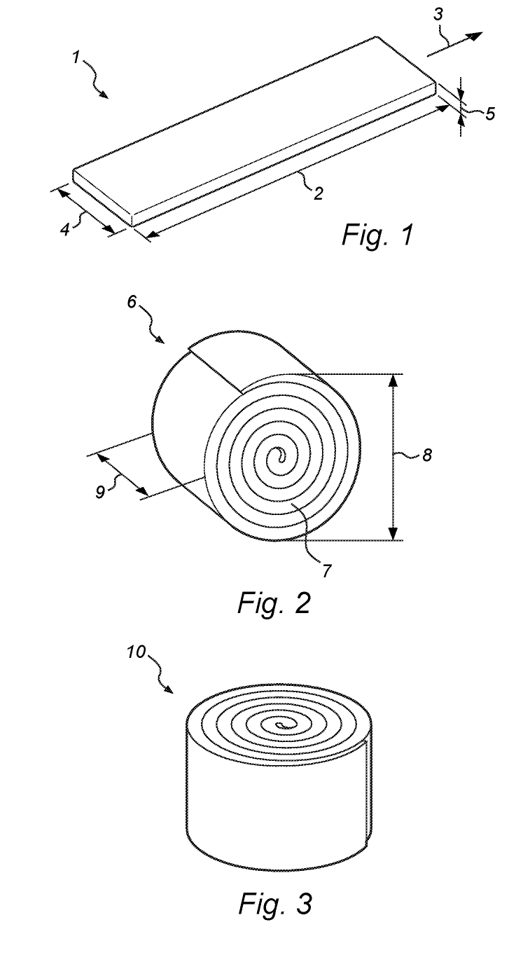

FIG. 1 shows a perspective view of an elongated dough piece 1, having a length 2 defined in a direction of elongation 3, a width 4 perpendicular to the direction of elongation and a thickness 5.

FIG. 2 shows a perspective view of a cylindrical shaped dough piece 6 obtained by curling up the elongated dough piece as shown in FIG. 1 over its longitudinal side in its direction of elongation 3. The dough piece is hereby rolled about an axis extending in a width direction of the dough piece, perpendicular to its direction of elongation. The resulting dough piece 6 takes the shape of a cylinder with ends having the approximate form of an arithmetic spiral 7. The cylinder furthermore has a diameter 8 and a height 9 that equals the width 4 of the elongated dough piece 1, wherein the percentage difference between the height 9 and the diameter 8 is lower than 5%.

FIG. 3 shows a perspective view of an upright dough piece 10 obtained by flipping cylindrical shaped dough piece 6 as shown in FIG. 2.

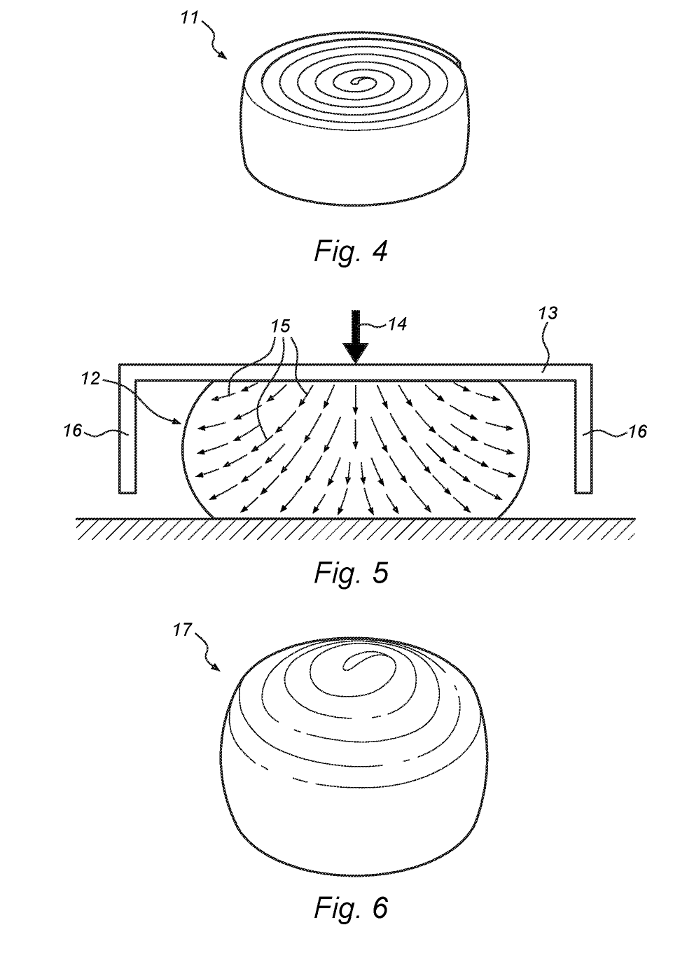

FIG. 4 shows a perspective view of a compressed dough piece 11 obtained by moulding the upright dough piece 10 as shown in FIG. 3. Due to a compression force exerted on the dough piece in an axial direction, the dough piece compressed in an axial direction and expanded in a radial direction.

FIG. 5 shows a sectional view of a dough piece 12 during the moulding step. A mould 13 is placed over the dough piece 12, after which a compressive force 14 is exerted on the dough piece 12 in an axial direction. This compressive force 14 introduces internal forces or stresses 15 within the dough piece 12, that cause the dough piece to extend in a radial direction. After removing the compressive force 14 by lifting the mould 13, residual stresses remain present in the dough piece, which residual stresses typically decrease in an outward radial direction of the dough piece due to the radial expansion. The mould 13 is provided with a side wall 16 to limit expansion of the dough piece up to a certain extend. Before the mould 13 is placed on the dough piece 12, the dough piece is typically sprinkled with strewing material or corn starch to prevent sticking of the mould to the dough piece.

FIG. 6 shows a perspective view of a rounded bread 17 resulting from the baking process. During the baking process, the compressed dough piece 11 of FIG. 4 rises, at least in part by the residual stresses present in de dough piece after the moulding step, to a final, rounded shape.

1. A method for producing a dough piece, comprising the steps of:
A) providing an elongated dough piece,
B) curling up the dough piece into a cylindrical shape,
C) arranging the curled up dough piece to an upright position wherein its cylinder axis is oriented substantially perpendicular to a support plane, and
D) moulding the dough piece by compressing the dough piece in an axial direction.

2. The method according to claim 1, wherein B) comprises rolling the dough piece about an axis extending in a width direction of the dough piece, perpendicular to the direction of elongation of the dough piece.

3. The method according to claim 2, wherein A) comprises providing an elongated dough piece having a width substantially equal to the diameter of an arithmetic spiral having a curve length equal to the length of the elongated dough piece and a distance between successive turnings equal to the thickness of the elongated dough piece.

4. The method according to claim 1, comprising sprinkling the dough piece with strewing material prior to D).

5. The method according to claim 1, wherein D) comprises introducing residual stresses into the dough piece, wherein the residual stresses decrease in outward radial direction of the dough piece.

6. The method according to claim 1, wherein D) comprises expanding the dough piece in a radial direction.

7. The method according to claim 6, wherein D) comprises expanding the dough piece in the radial direction to substantially the same extend as to which it is compressed in the axial direction.

8. The method according to claim 6, wherein D) comprises limiting the expansion of the dough piece in a radial direction.

9. The method according to claim 8, wherein the expansion of the dough piece is limited by the mould.

10. The method according to claim 1, comprising transporting the dough piece in the direction of elongation of the dough piece.

11. The method according to claim 1, wherein A) comprises providing a gluten-free bread dough piece comprising a composition without wheat, rye or spelt or gluten forming proteins but for instance starch such as potato starch, bean starch, corn starch, pea starch, rice flour, teff flour, tapioca flour, chicken proteins, gel formers, water, yeast and salt instead. Gluten-free dough is especially sticky and therefore in particular benefits from application of a method according to the invention.

12. A dough piece produced using a method according to claim 1.

13. A method for producing a rounded bread comprising applying a method for producing a dough piece according to claim 1 followed by subjecting the dough piece to a baking process.

14. The method according to claim 13, wherein the baking process comprises enabling unbounded rising of the dough piece.

15. A rounded bread produced using a method according to claim 13.

16. A rounded bread produced using a method according to claim 14.
